(19) United States
(12) Patent Application Publication
(10) Pub. No.: US 2018/0204695 A1
(43) Pub. Date: Jul. 19, 2018

(54) POWER-ASSISTED RESET MAGNETIC PROXIMITY SWITCH

(71) Applicants: FOSHAN Yif Technologies Co., Ltd., Foshan, Guangdong (CN); CHUANDONG MAGNETIC ELECTRONICS CO., LTD, Foshan, Guangdong (CN)

(72) Inventor: Li Liu, Foshan, Guangdong (CN)

(21) Appl. No.: 15/743,945

(22) PCT Filed: Apr. 15, 2016
(86) PCT No.: PCT/CN2016/079458

§ 371 Date: Jan. 11, 2018

(30) Foreign Application Priority Data
Nov. 24, 2015 (CN) 201510827218.9

(51) Int. Cl. H01H 36/00

(52) U.S. Cl. CPC H01H 36/00

(57) ABSTRACT

A power-assisted reset magnetic proximity switch that has a shell that has an inner chamber provided with a magnet, a first terminal and a second terminal; the first terminal and the second terminal are disposed in parallel at intervals, each vertically inserted into the lower end plate of the shell; the upper end of the second terminal is transversely provided with an elastic contact piece; the free end of the elastic contact piece is disposed above the first terminal; a power-assisted rod is disposed in the shell, outer end of which is hinged with the shell; an elastic tongue piece is disposed on the elastic contact piece; the free end of the elastic tongue piece abuts against the inner end of the power-assisted rod; the outer end of the power-assisted rod is provided with a limiting insertion plate that forms an L-shaped structure with the power-assisted rod.

### TECHNICAL FIELD OF THE INVENTION

The present invention relates to the technical field of proximity switches, and more particularly, to a power-assisted reset magnetic proximity switch.

### BACKGROUND OF THE INVENTION

A magnetic proximity switch is a proximity sensor that uses a magnetic element to detect the positional variation of nearby objects, which is capable of converting the non-electrical quantities or electromagnetic quantities into required electrical signals, thereby serving the purposes of controlling and measuring. In the field of robot application technologies, automatic navigation and positioning detection are crucial for achieving an intelligent control. Compared with commonly-used controllers, proximity switches possess incomparable advantages in positioning detection and execution control. Due to the high performances of target detection and safety control, magnetic proximity switches are widely applied in various industries such as magnetic-fuse bomb heads, magnetic-detection underwater mines, spacecraft magnetic-flux-gate, high-speed trains, automatic elevators, thermo-magnetic power generation systems, automatic processing equipments, automobile speed control systems, automobile skylight control systems, door switches, cover opening and closing mechanisms and pressure detection devices, etc.

Chinese patent CN201410299835.1 discloses a novel magnetic proximity switch that comprises a shell, a magnet able to move upward and downward within the upper portion of the shell, and two wiring terminal pieces that are disposed at the bottom of the shell in parallel, wherein the upper end of one wring terminal piece is provided with an elastic piece, the middle portion of the shell is provided with a swing-able power-assisted rod and a limiting mechanism that interacts with the power-assisted rod, and the elastic piece is provided with an elastic tongue piece that abuts against the power-assisted portion of the power-assisted rod. Although this design can solve problems such as the metal fatigue of the elastic tongue piece that is caused by a large travel range of the power-assisted rod and the magnet in the motion mechanism, the swing fulcrum of the power-assisted rod, the power-assisted portion and the moment fulcrum of the elastic tongue piece are located on the same horizontal line, and the force arm between the moment fulcrum and the swing fulcrum is long. Thus, a large ratio between the travel range of one end of the power-assisted rod in the limiting mechanism and the swing range of the power-assisted portion can be created, resulting in a low moment conversion efficiency of the power-assisted rod and a poor power-assisted travel effect. The magnet moves upward and downward, thereby propelling the power-assisted rod to swing. Thus, the elastic piece is further propelled to move. Due to the friction exists among the magnet, the shell and the power-assisted rod, the magnetic powder or the electroplating layer provided on the components can be easily abraded-off, seriously affecting the reliability of the electrical connection between the contacts of the elastic piece and the wiring terminal piece. Furthermore, although the moment conversion of the power-assisted rod ensures a stable control of the switching-on/off of the large current, the arcing problem occurring between the contacts during the variation of the current load cannot be solved. Furthermore, due to the surface oxidation of the contacts and the metal components, the operating stability and the function life of the products can be seriously affected.

In conclusion, the shortcomings of traditional magnetic proximity switches are urgent problems that need to be solved for those skilled in this field.

### SUMMARY OF THE INVENTION

The purpose of the present invention is to solve the shortcomings in the prior art and provide a stable and reliable power-assisted reset magnetic proximity switch having a compact structure.

To achieve the above purpose, the present invention adopts the following technical solution:

A power-assisted reset magnetic proximity switch comprises a shell; the inner chamber of the shell is provided with a magnet, a first terminal and a second terminal; the first terminal and the second terminal are disposed in parallel at intervals, and each terminal vertically extends into the lower end plate of the shell; the upper end of the second terminal is transversely provided with an elastic contact piece; the free end of the elastic contact piece is disposed above the first terminal; a power-assisted rod is disposed in the shell, and the outer end of the power-assisted rod is hinged with the shell; an elastic tongue piece is disposed on the elastic contact piece; the free end of the elastic tongue piece abuts against the inner end of the power-assisted rod; the outer end of the power-assisted rod is provided with a limiting insertion plate that forms an L-shaped structure with the power-assisted rod; a power-assisted reset mechanism, which interacts with the limiting insertion plate, is disposed in the shell that is located above the outer end of the power-assisted rod; the magnet is disposed between the power-assisted rod and the upper end plate of the shell, and is integrally linked with the power-assisted rod.

In another aspect of the present invention, the power-assisted reset mechanism comprises a stop plate and a power-assisted elastic piece. The stop plate is vertically fixed on the inner wall of the shell. The power-assisted elastic piece is oppositely spaced apart from one side of the stop plate, and the power-assisted elastic piece that interacts with the shell is connected to the shell. The limiting insertion plate, which can move leftward and rightward, is inserted between the stop plate and the power-assisted elastic piece.

In another embodiment of the present invention, the two ends of the power-assisted elastic piece are respectively provided with a fixing end piece and a guiding end piece. The power-assisted elastic piece, the fixing end piece and the guiding end piece are integrally connected to form an Ω-shaped structure. The opening of the power-assisted elastic plate faces a direction away from the limiting insertion plate. The inner wall of the shell is provided with a fixed receiving part, and the fixing end piece is inserted into the fixed receiving part. A telescopic receiving part is provided underneath the fixed receiving part. The guiding end piece that is capable of moving upward and downward is inserted into the telescopic receiving part.

In another embodiment of the present invention, the fixed receiving part comprises two locating plates that are disposed at intervals opposite from each other. The two opposite inner side surfaces of the locating plates are each respectively provided with a rack. The racks of the two locating plates are disposed to correspond with each other in a staggered up-and-down manner. The fixing end piece is inserted between the two racks and fixed to the locating plates.

In another embodiment of the present invention, the upper surface of the free end of the power-assisted rod is provided with a holding tray, and the magnet is disposed between the holding tray and the upper end plate of the shell. The upper end surface of the holding tray is provided with a mounting port. The lower end of the magnet extends through the mounting port and is in an interference fit with the mounting port.

In another embodiment of the present invention, the height difference between the bottom surface of the mounting port and the upper end surface of the holding tray is defined as “A”, and the height of the magnet is defined as “H”, the ratio of A to H is within a range of 0.2-1.

In another embodiment of the present invention, the inner wall of the shell, which is located above the first terminal, is provided with a fulcrum, and the outer end of the power-assisted rod is provided with a lantern ring. The lantern ring is sleeved on the fulcrum, and is in a running fit with the fulcrum. The limiting insertion plate is disposed on the lantern ring. The limiting insertion plate, the lantern ring and the power-assisted rod together form an integrated L-shaped structure.

In another embodiment of the present invention, a transverse hinge is disposed at the upper end of the first terminal, and the hinge is provided with a stationary contact. The free end of elastic contact piece is disposed above the hinge, and the elastic contact piece is provided with a movable contact that interacts with the stationary contact.

In another embodiment of the present invention, the inner side wall of the shell that is located between the hinge and the power-assisted rod is provided with a J-shaped arc-guiding strip. The arc-guiding strip is transversely disposed, and the hook portion of the J-shaped arc-guiding strip is disposed to correspond to the movable contact.

Compared with the prior art, the present invention has the following advantages:

The present invention has a more suitable structure. Through the interaction between the limiting insertion plate and the power-assisted reset mechanism, the travel angle between the power-assisted rod and the magnet can be controlled. The power-assisted elastic piece pushes the limiting insertion plate when the magnet is reset, thereby interacting with the elastic tongue piece during the switch-off process. The magnet which integrally rotates with the power-assisted rod rotates along with a holding tray, thereby protecting the reliability of the electrical connection from being affected by the magnetic powder abraded-off from the magnet. Meanwhile, the present invention is provided with an arc-guiding strip structure for protecting the separation of contacts, through which the arcing problem can be prevented from affecting the insulation shell and the components. Thus, the operating stability of the proximity switch can be improved, and prolongs the life of the proximity switch.

### BRIEF DESCRIPTION OF THE DRAWINGS

To clearly expound the technical solution of the present invention, the drawings and embodiments are hereinafter combined to illustrate the present invention. Obviously, the drawings are merely some embodiments of the present invention and those skilled in the art can associate themselves with other drawings without paying creative labor.

FIG. 1 is an explosive view of the present invention;

FIG. 2 is a schematic diagram illustrating the internal assembly structure of the present invention;

FIG. 3 is an enlarged structural diagram of part B in FIG. 2; and

FIG. 4 is a schematic diagram illustrating an internal plane structure when the present invention is in a switched-on state.

### MARKING INSTRUCTIONS OF THE DRAWINGS

1, Shell; 2, Elastic Contact Piece; 3, Power-assisted Rod; 4, Magnet; 11, The First Terminal; 12, The Second Terminal; 13, Fulcrum; 14, Stationary Contact; 16, Hinge; 17, Arc-guiding Strip; 21, Elastic Tongue Piece; 22, Movable Contact; 31, Limiting Insertion Plate; 32, Lantern Ring; 33, Holding Tray; 34, Mounting Port; 41, Stop Plate; 42, Power-assisted Elastic Piece; 43, Fixing End Piece; 44, Guiding End Piece; 45, Telescopic Receiving Part; 46, Locating Plate; 47, Rack.

### DETAILED DESCRIPTION OF THE INVENTION

Drawings and detailed embodiments are combined hereinafter to elaborate the technical principles of the present invention.

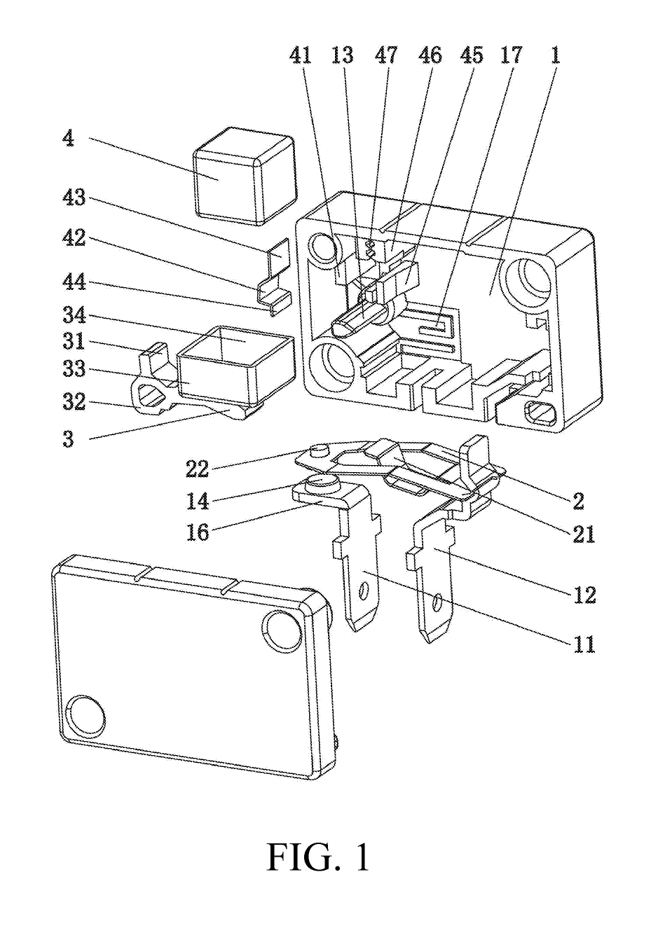

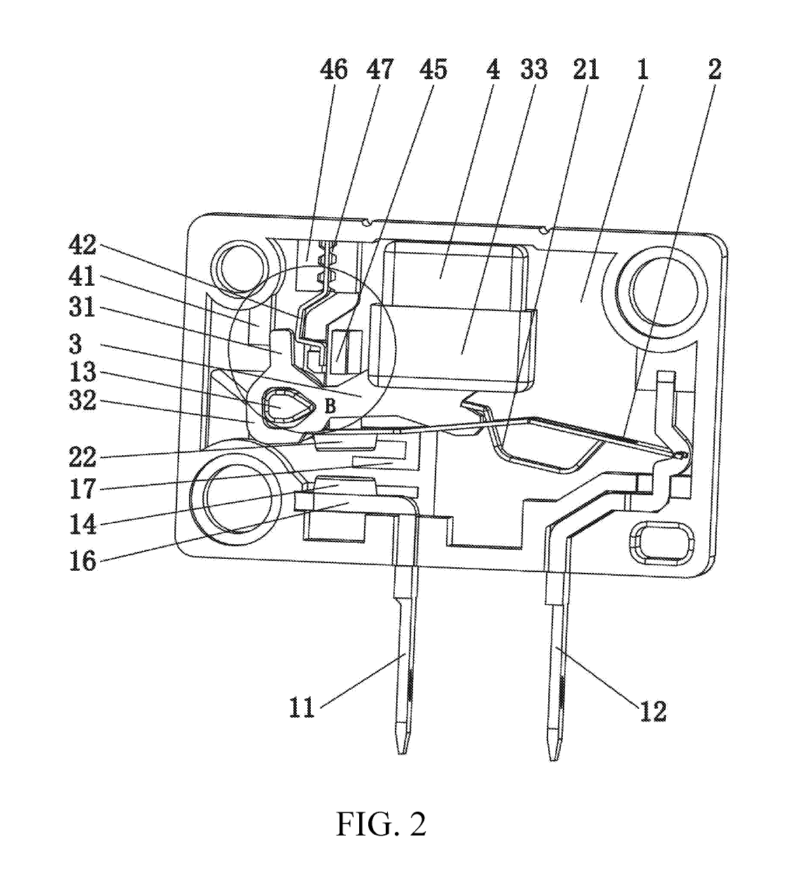

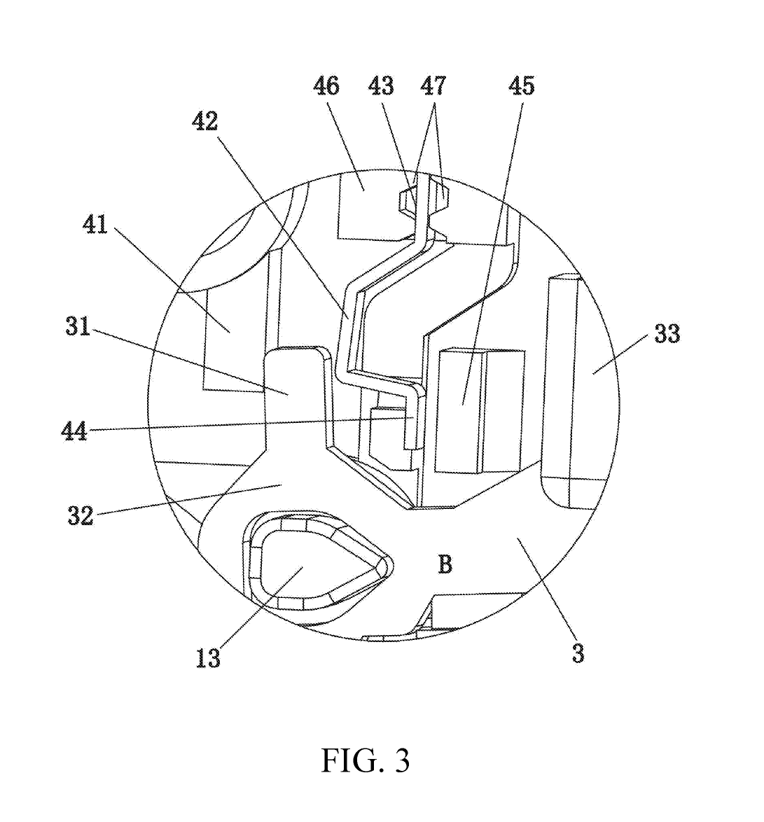

As shown in FIGS. 1-3, the power-assisted reset magnetic proximity switch of the present invention comprises a shell 1. The inner chamber of the shell 1 is provided with a magnet 4, a first terminal 11 and a second terminal 12. The first terminal 11 and the second terminal 12 are disposed in parallel at intervals, and each terminal is vertically inserted into the lower end plate of the shell 1. The upper end of the second terminal 12 is transversely provided with an elastic contact piece 2. The free end of the elastic contact piece 2 is disposed above the first terminal 11. A power-assisted rod 3 is disposed in the shell, and the outer end of the power-assisted rod 3 is hinged with the shell 1. An elastic tongue piece 21 is disposed on the elastic contact piece 2. The free end of the elastic tongue piece 21 abuts against the inner end of the power-assisted rod 3. The magnet 4 propels the power-assisted rod 3 to move, and this enables the elastic contact piece 2 to switch-on the circuit between the first terminal 11 and the second terminal 12. The moment of the elastic tongue piece 21 and the power-assisted rod 3 provide a reset force to the elastic contact piece, thereby achieving a stable control of the switching-on/off of the proximity switch. As the operating principle is similar to the prior art, it is briefly described herein.

The outer end of the power-assisted rod 3 is provided with a limiting insertion plate 31 that forms an L-shaped structure with the power-assisted rod 3. The outer end of the power-assisted rod 3 is hinged with the shell 1, thereby allowing the inner end of the power-assisted rod 3 to swing upward and downward. A power-assisted reset mechanism, which interacts with the limiting insertion plate 31, is disposed in the shell 1 that is located above the outer end of the power-assisted rod 3. The power-assisted reset mechanism is used for pushing the limiting insertion plate 31, thereby enabling the inner end of the power-assisted rod 3 to move upwards. Thus, the elastic tongue piece 21 is power-assisted to reset, thereby propelling the power-assisted rod 3 and the elastic contact piece 2 to achieve a switching-off motion. The limiting insertion plate 31 that is configured in an “L” shape interacts with the power-assisted reset mechanism, thereby defining the upward swinging limit of the power-assisted rod 3. In order to conveniently describe the moment variation of the power-assisted rod 3, the point where the outer end of the power-assisted rod 3 and the shell 1 are hinged is defined as “M”, the point where the inner end of the power-assisted rod 3 and the elastic tongue piece are connected is defined as “N”, and the point where the elastic contact piece 2 and the second terminal 12 are connected is defined as “K”. The connecting lines between the points M, N and K form a triangle moment relation, wherein the inner angle of the point N is an obtuse angle, and the height of the triangle that corresponds to the point N is defined as “H”. When the power-assisted rod 3 reaches the upper limit, namely, when the power-assisted rod 3 is in an initial switching-off state, H is the maximum value, and the moment generated by the elastic tongue piece 21 that is located on the connecting line between the points K and N provides an upward supporting force to the point N of the power-assisted rod. When the magnet 4 propels the point N of the power-assisted rod 3 to rotate downwards to reach a lower limit, H is the minimum value and is greater than 0. Thus, the elastic contact piece 2 is in a switching-on state, and the elastic tongue piece 21 still imposes an upward reset moment on the power-assisted rod 3. As a result, after the magnet 4 is released, the elastic tongue piece 21 can provide a large reset torque force, thereby ensuring a high sensitivity of the switching-off of the proximity switch.

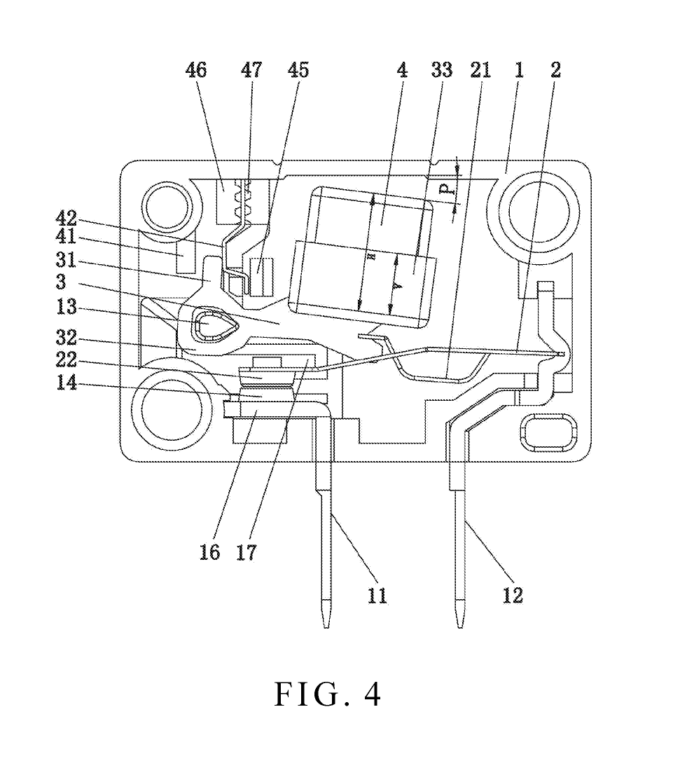

As shown in FIG. 4, the power-assisted reset mechanism comprises a stop plate 41 and a power-assisted elastic piece 42. The stop plate 41 is vertically fixed on the inner wall of the shell 1. The power-assisted elastic piece 42 is oppositely spaced apart from one side of the stop plate 41, and the power-assisted elastic piece 42 that interacts with the shell 1 is connected to the shell 1. The limiting insertion plate 31, which can move to the left and right is inserted between the stop plate 41 and the power-assisted elastic piece 42. The distance between the stop plate 41 and the power-assisted elastic plate 42 and the contraction limit of the power-assisted elastic plate 42 are combined to form the left-right swinging range of the limiting insertion plate 31. When the limiting insertion plate 31 approaches the stop plate 41, the inner end of the power-assisted rod 3 can move upwards to reach an initial upper limit. When the magnet 4 is propelled by an external magnetic component to move downwards for a certain angle, the inner end of the power-assisted rod 3 can move downwards to a lower limit, thereby achieving the electrical connection between the contacts. At this moment, the angle formed between the upper end surface of the magnet 4 and the inner side surface of the upper end plate of the shell 1 is the travel angle P of the magnet 4. Meanwhile, the limiting insertion plate 31 abuts against and compresses the power-assisted elastic piece 42. When the power-assisted elastic piece 42 reaches the contraction limit, the distance between the power-assisted elastic piece 42 and the stop plate 41 equals to the travel range of the limiting insertion plate 31, and the ratio between the travel range of the limiting insertion plate 31 and the thickness of the limiting insertion plate 31 is in direct proportion to the travel angle P of the magnet 4. Thus, the power-assisted elastic piece 42 provides a reset force to the limiting insertion plate 31, thus propelling the limiting insertion plate 31 and the power-assisted rod 3 to return to the initial position. Therefore, the switching-off of the proximity switch can achieve a high sensitivity and reliability.

The two ends of the power-assisted elastic piece 42 are respectively provided with a fixing end piece 43 and a guiding end piece 44. The power-assisted elastic piece 42, the fixing end piece 43 and the guiding end piece 44 are integrally connected to form an Ω-shaped structure. The opening of the power-assisted elastic plate 42 faces a direction away from the limiting insertion plate 31. The inner wall of the shell 1 is provided with a fixed receiving part, and the fixing end piece 43 is inserted into the fixed receiving part. A telescopic receiving part 45 is provided underneath the fixed receiving part. The guiding end piece 44 capable of moving upward and downward is inserted into the telescopic receiving part 45. One end of the Ω-shaped elastic structure is fixed to the fixed receiving part through the fixing end piece 43. The power-assisted elastic piece 42 extends downwards when it is in a compressed state, enabling the guiding end piece 44 to extend into the telescopic receiving part 45. The extension range of the power-assisted elastic piece 42 is limited by the distance between the fixed receiving part and the telescopic receiving part 45. When the lower end of the power-assisted elastic piece 42 extends to abut against the upper opening of the telescopic receiving part 45, the ductility of the power-assisted elastic piece 42 disappears, allowing the swinging range of the limiting insertion plate 31 to be limited, and which further limits the downward travel range of the inner end of the power-assisted rod 3.

The fixed receiving part comprises two locating plates 46 that are oppositely disposed at intervals. The two opposite inner side surfaces of the locating plates 46 are each respectively provided with a rack 47. The racks 47 of the two locating plates 46 are disposed to correspond with each other in an up-and-down staggered manner. The fixing end piece 43 is inserted between the two racks 47, and is fixed to the locating plates 46. The racks 47, which are disposed in a staggered manner, are connected to the fixing end piece 43 through the meshing friction force. Thus, a relative displacement of the racks caused by the extension and contraction of the power-assisted elastic piece 42 can be avoided. Meanwhile, because the fixing end piece and the fixed receiving part are in friction connection, the assembly efficiency and the maintenance convenience are greatly improved.

The magnet 4 is disposed between the power-assisted rod 3 and the upper end plate of the shell 1, and is integrally linked with the power-assisted rod 3. The magnet 4 that integrally rotates with the power-assisted rod 3 rotates along with a holding tray 33, thereby protecting the reliability of the electrical connection from being affected by the magnetic powder abraded-off from the magnet 4. The upper side surface of the free end of the power-assisted rod 3 is provided with the holding tray 33, and the magnet 4 is disposed between the holding tray 33 and the upper end plate of the shell 1. The upper end surface of the holding tray 33 is provided with a mounting port 34. The lower end of the magnet 4 extends through the mounting port 34 and is in an interference fit with the mounting port 34. The holding tray 33 and the power-assisted rod 3 are made from an insulating material, and are integrally machined. As a result, the assembly efficiency and the relative position accuracy are improved.

When the height difference between the bottom surface of the mounting port 34 and the upper end surface of the holding tray 33 is defined as “A”, and the height of the magnet 4 is defined as “H”, the ratio of A to H is within a range of 0.2-1. The magnet 4 can be partially or completely assembled with the holding tray 33, and the connection strength between the magnet 4 and the holding tray 33 varies along the ratio of A to H. The contact surface between the magnet 4 and the holding tray 33 is provided with a magnetism-isolating material. Alternatively, the holding tray 33 can be made from a magnetism-isolating material. Therefore, the magnetic-induction driving control in a single direction is achieved in various operating environments.

The inner wall of the shell 1, which is located above the first terminal 11, is provided with a fulcrum 13, and the outer end of the power-assisted rod 3 is provided with a lantern ring 32. The lantern ring 32 is sleeved on the fulcrum 13, and is in a running fit with the fulcrum 13. The limiting insertion plate 31 is disposed on the lantern ring 32. The limiting insertion plate 31, the lantern ring 32 and the power-assisted rod 3 form an integrated L-shaped structure.

A transverse hinge 16 is disposed at the upper end of the first terminal 11, and the hinge 16 is provided with a stationary contact 14. The free end of elastic contact piece 2 is disposed above the hinge 16, and the elastic contact piece 2 is provided with a movable contact 22 that interacts with the stationary contact 14. The inner side wall of the shell 1 that is located between the hinge 16 and the power-assisted rod 3 is provided with a J-shaped arc-guiding strip 17. The arc-guiding strip 17 is transversely disposed, and the hook portion of the J-shaped arc-guiding strip 17 is disposed to correspond to the movable contact 22. The control range of the arc-guiding strip 17 is matched with the motion range of the movable contact 22, thus preventing the arcing problem that occurs in the switching-on/off process of the movable contact 22 and the stationary contact 14 from affecting other internal components. Thus, the operating stability and the functional life of the overall structure can be greatly improved.

The description of above embodiments allows those skilled in the art to realize or use the present invention. Without departing from the spirit and essence of the present invention, those skilled in the art can combine, change or modify correspondingly according to the present invention. Therefore, the protective range of the present invention should not be limited to the embodiments above but conform to the widest protective range which is consistent with the principles and innovative characteristics of the present invention. Although some special terms are used in the description of the present invention, the scope of the invention should not necessarily be limited by this description. The scope of the present invention is defined by the claims.

1. A power-assisted reset magnetic proximity switch, comprising:
a shell, wherein the inner chamber of the shell is provided with a magnet,
a first terminal and a second terminal, wherein the first terminal and the second terminal are disposed in parallel at intervals, and each terminal vertically extends into the lower end plate of the shell, wherein the upper end of the second terminal is transversely provided with an elastic contact piece, wherein the free end of the elastic contact piece is disposed above the first terminal, wherein a power-assisted rod is disposed in the shell, wherein the outer end of the power-assisted rod is hinged with the shell, wherein an elastic tongue piece is disposed on the elastic contact piece, wherein the free end of the elastic tongue piece abuts against the inner end of the power-assisted rod, wherein the outer end of the power-assisted rod is provided with a limiting insertion plate that forms an L-shaped structure with the power-assisted rod, wherein a power-assisted reset mechanism interacts with the limiting insertion plate, wherein the power-assisted reset mechanism is disposed in the shell that is located above the outer end of the power-assisted rod, wherein the magnet is disposed between the power-assisted rod and the upper end plate of the shell and integrally linked with the power-assisted rod.

2. The power-assisted reset magnetic proximity switch of claim 1, wherein the power-assisted reset mechanism further comprising a stop plate and a power-assisted elastic piece, wherein the stop plate is vertically fixed on the inner wall of the shell, wherein the power-assisted elastic piece is oppositely spaced apart from one side of the stop plate, and the power-assisted elastic piece that interacts with the shell is connected to the shell, wherein the limiting insertion plate capable of moving left and right, is inserted between the stop plate and the power-assisted elastic piece.

3. The power-assisted reset magnetic proximity switch of claim 2, wherein the two ends of the power-assisted elastic piece are each provided with a fixing end piece and a guiding end piece, wherein the power-assisted elastic piece, the fixing end piece and the guiding end piece are integrally connected to form an Ω-shaped structure, wherein the opening of the power-assisted elastic plate faces in a direction away from the limiting insertion plate, wherein the inner wall of the shell is provided with a fixed receiving part, and the fixing end piece is inserted into the fixed receiving part, wherein a telescopic receiving part is provided underneath the fixed receiving part, wherein the guiding end piece capable of moving upward and downward is inserted into the telescopic receiving part.

4. The power-assisted reset magnetic proximity switch of claim 3, wherein the fixed receiving part further comprising two locating plates oppositely disposed at intervals, wherein the two opposite inner side surfaces of the locating plates are each provided with a rack, wherein the racks of the two locating plates correspond to each other in an up-and-down staggered manner, wherein the fixing end piece is inserted between the two racks and fixed to the locating plates.

5. The power-assisted reset magnetic proximity switch of claim 1, wherein the upper side surface of the free end of the power-assisted rod is provided with a holding tray, wherein the magnet is disposed between the holding tray and the upper end plate of the shell, wherein the upper end surface of the holding tray is provided with a mounting port, wherein the lower end of the magnet extends through the mounting port and is in an interference fit with the mounting port.

6. The power-assisted reset magnetic proximity switch of claim 5, wherein the height difference between the bottom surface of the mounting port and the upper end surface of the holding tray is defined as “A”, and the height of the magnet is defined as “H”, the ratio of A to H is within a range of 0.2-1.

7. The power-assisted reset magnetic proximity switch of claim 1, wherein the inner wall of the shell located above the first terminal is provided with a fulcrum, wherein the outer end of the power-assisted rod is provided with a lantern ring, wherein the lantern ring is sleeved on the fulcrum and in a running fit with the fulcrum, wherein the limiting insertion plate is disposed on the lantern ring, wherein the limiting insertion plate, the lantern ring and the power-assisted rod form an integrated L-shaped structure.

8. The power-assisted reset magnetic proximity switch of claim 1, wherein a transverse hinge is disposed at the upper end of the first terminal, wherein the hinge is provided with a stationary contact, wherein the free end of elastic contact piece is disposed above the hinge, and wherein the elastic contact piece is provided with a movable contact that interacts with the stationary contact.

9. The power-assisted reset magnetic proximity switch of claim 8, wherein the inner side wall of the shell located between the hinge and the power-assisted rod is provided with a J-shaped arc-guiding strip, wherein the arc-guiding strip is transversely disposed, wherein the hook portion of the J-shaped arc-guiding strip is disposed to correspond to the movable contact.
